(19) United States
(12) Patent Application Publication
(10) Pub. No.: US 2017/0000097 A1
(43) Pub. Date: Jan. 5, 2017

(54) Modular Fishing Lure System

(71) Applicant: Scott Thomas, Lewisville, TX (US)

(72) Inventor: Scott Thomas, Lewisville, TX (US)

(21) Appl. No.: 15/113,796

(22) PCT Filed: Jan. 24, 2014
(86) PCT No.: PCT/US2014/012985

§ 371 Date: Jul. 22, 2016

(51) Int. Cl. A01K 85/18; A01K 85/01

(52) U.S. Cl. CPC A01K 85/18; A01K 85/01

(57) ABSTRACT

A modular fishing lure assembly is capable of hand-assembly and disassembly in the field and includes multiple, interchangeable body and head components, and connector plugs. The connector plugs are releasably, and by hand, connectable to both a body and head component to allow creation of a variety of fishing lures, hand-assembled in the field. A multiple of nose components for controlling the action of the lure in the water and adapted for releasable connection by hand to the head components are provided. Stowage plugs, interchangeable with the connector plugs, allow connection of the still-attached head to the rod.

### CROSS-REFERENCE TO RELATED APPLICATIONS

None.

### TECHNICAL FIELD

The disclosure relates, in general, to fishing lures, and more specifically to a modular system for creating lures using selected components.

### BRIEF DESCRIPTION OF THE DRAWINGS

For a more complete understanding of the features and advantages of the present disclosure, reference is now made to the detailed description of the disclosure along with the accompanying figures in which corresponding numerals in the different figures refer to corresponding parts and in which:

FIG. 1 is an elevational schematic of an exemplary modular fishing lure system according to an aspect of the invention;

FIG. 2 is a top view schematic of an exemplary body component for a modular fishing lure system according to an aspect of the invention;

FIG. 3 is an elevational schematic of an exemplary head component for a modular fishing lure system according to an aspect of the invention;

FIG. 4 is an orthogonal view of an exemplary connector plug component for a modular fishing lure system according to an aspect of the invention;

FIG. 5 is an orthogonal view of an exemplary stowing component for a modular fishing lure system according to an aspect of the invention;

FIGS. 6A-D are exemplary alternate nose components for use according to the invention;

FIGS. 7A-D are exemplary alternate body components for use according to the invention;

FIG. 8 is a schematic of exemplary accessories for use in embodiments according to the invention;

FIG. 9 is an elevational view of an exemplary alternate soft or live bait component for use according to an aspect of the invention; and

FIG. 10 is a schematic view of an exemplary multi-point eye for use according to an aspect of the invention.

### DETAILED DESCRIPTION

The present disclosures are described by reference to drawings showing one or more examples of how the disclosures can be made and used. In these drawings, reference characters are used throughout the several views to indicate like or corresponding parts. In the description which follows, like or corresponding parts are marked throughout the specification and drawings with the same reference numerals, respectively. The drawings are not necessarily to scale and the proportions of certain parts have been exaggerated to better illustrate details and features of the disclosure. In the following description, terms such as “up”, “upper,” “down”, “lower”, “below”, “longitudinally,” “axially,” and the like, refer typically to orientation of components or directions in the Figures. It is understood by those skilled in the art that the use of directional terms such as above, below, upper, lower, upward, downward and the like are used in relation to the illustrative embodiments as they are depicted in the figures. Where this is not the case and a term is being used to indicate a required orientation, the specification will make such clear.

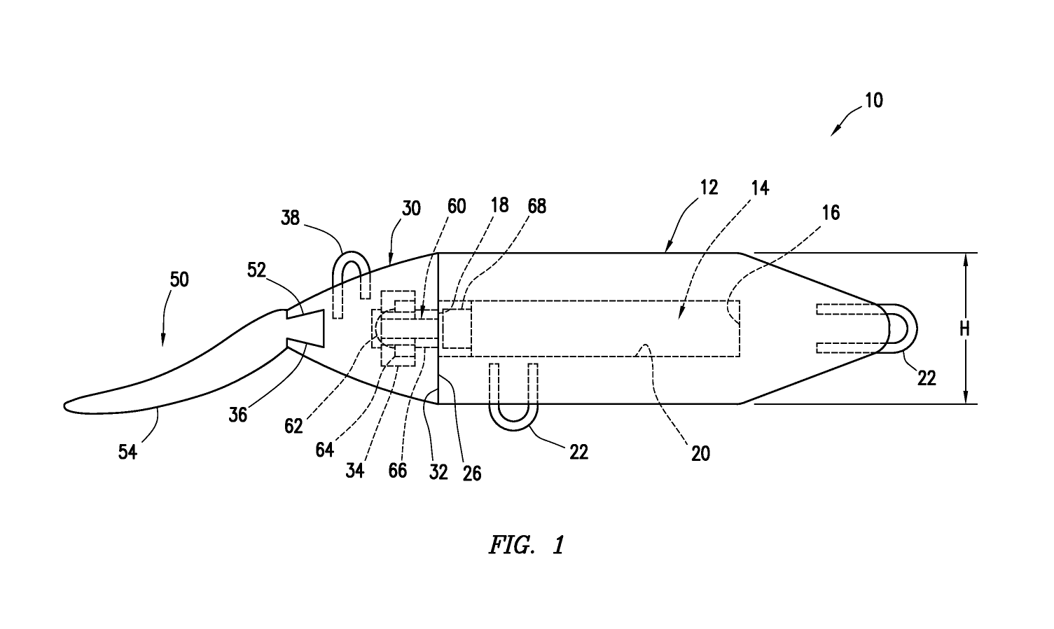

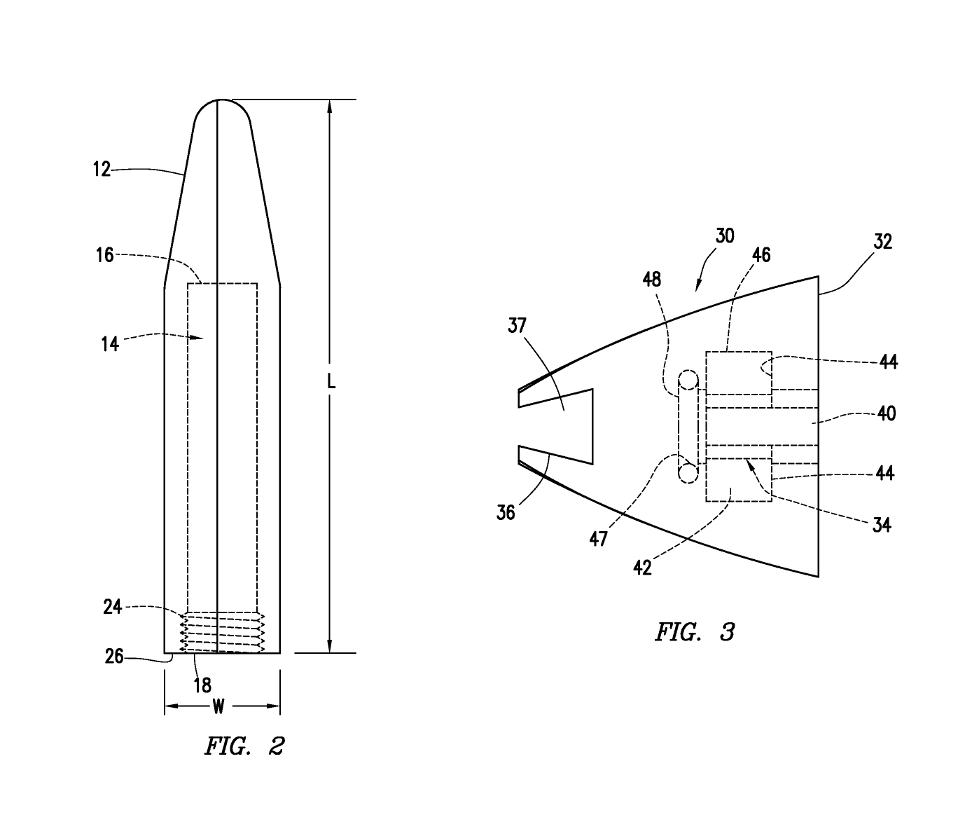

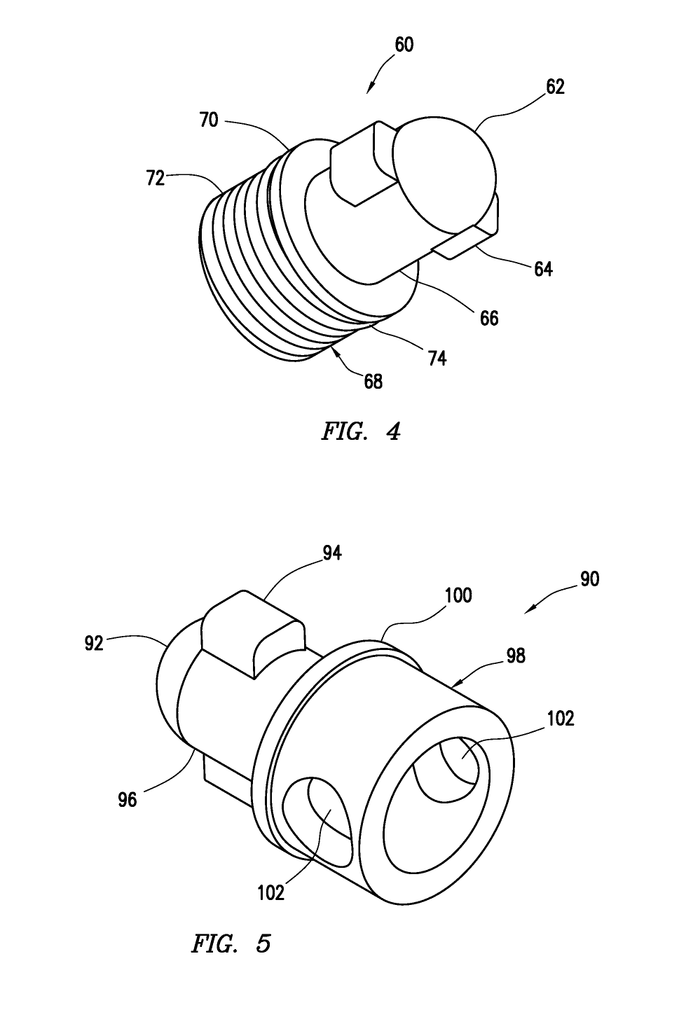

FIG. 1 is an elevational schematic of an exemplary modular fishing lure system according to an aspect of the invention. FIG. 2 is a top view schematic of an exemplary body component for a modular fishing lure system according to an aspect of the invention. FIG. 3 is an elevational schematic of an exemplary head component for a modular fishing lure system according to an aspect of the invention. FIG. 4 is an orthogonal view of an exemplary connector plug component for a modular fishing lure system according to an aspect of the invention. FIG. 5 is an orthogonal view of an exemplary stowing component for a modular fishing lure system according to an aspect of the invention. The system is discussed with reference to the various figures with like parts having like numbers throughout. The figures present only specific and exemplary embodiments only.

Generally, a modular fishing lure system is presented providing easy and quick field assembly. Common components are the body component 12, head component 30, nose component 50, and connector plug 60. The sportsman selects each component for assembly preferably from an array of potential components. The particular body component 12 can be selected, for example, to imitate the shape and size of lure desired—long and skinny, short and fat, etc. The body component 12 includes one or more eyes 22 extending outwardly therefrom for connecting hooks as desired.

The body component 12 connects via connector plug 60 to the head component 30. The head component 30 can be selected by the sportsman based on desired shape, size, and to coordinate with the selected body component. An eye 38 provides for tying to a fishing line. A nose component 50 can be attached to the head component 30 by cooperating connections 36 and 52. Exemplary nose component choices can be, but are not limited to, shallow, medium and deep divers, and splash-spoons.

The connector plug 60 extends between the body component 12 and head component 30, attaching to each. Preferably the connector plug 60 is of a breakaway design. That is, a breakaway connector plug 60 can be selected to disconnect upon application of a selected force. For example, a 15 lb. breakaway plug can be selected for line rated to 15 lbs. A kit of parts can include multiple breakaway plugs of various line ratings, such as 10, 15, 25 lbs., etc. The plugs can be marked to indicate their rating. The breakaway design of the modular system allows retrieval of at least the head component 30 and nose component 50 in case of becoming snagged, etc. The modular system allows for manual disconnection by the sportsman of at least the head component 30 from the body 12 component (including hooks) after retrieving a caught fish, for safe stowage during transport, etc.

The connectors and connection devices for attaching and selectively releasing the component parts are hand-operated and do not require tools. Preferred connectors and connection devices rely on snap-in, friction fit, easily threaded fasteners, and the like. The connectors do not require use of tools, such as a screwdriver, pliers, a vise, etc., and do not require the creation by the user of corresponding screw holes or the like. Further, unlike prior art modular lures, the presented embodiments do not require use of wires, complex linkages, interconnecting shaped-wires connected through body passageways, biasing springs, multiple interlocking parts for a single connection, or other difficult-to-manipulate parts, such as those requiring threading through the body or head cavities and often specialized tools to assist in their use. For such disclosures, see, for example, U.S. Patent and Patent Application Publication Nos. 2008/0104877 to Claverie, 2006/0032109 to Chiodo, 2009/0126256 to Gregory, Pat. No. 5,992,083 to Deng, Pat. No. 6,058,643 to Luikart, Pat. No. 8,484,884 to Zuk, Pat. No. 5,142,811 to Freeman, Pat. No. 8,490,319 to Mancini, and 2012/0266517 to Burdick.

A stowage plug 90 (FIG. 5) is provided for ease of stowing and transport of the lure components, without requiring untying the head and nose from the line. The body component 12 and attached hooks can be safely stowed in a tackle box for example, while the head 30 (without hooks) still tied to the free end of the line can be releasably attached to the rod or some portion thereof.

The modular capacity of the system allows for the body component, including all attached hooks, to be stowed and handled separately, safely away from the rod and line. The head and nose components can be handled separately, with no hooks, for safer tying to or removal from a line and allowing for safe stowage to the rod and line. Further, the modular system allows for easy and safe disconnection of the lure body component (with hooks) from the head component after making a catch. The hooks and body component can then be more safely retrieved from the catch without interference from a rod, reel, the fishing line, etc. The modular components are easily hand-assembled, requiring no tools for assembly. With a breakaway plug, the head and nose components can be re-used even if the body is lost.

A kit having a plurality of interchangeable components allows for the creation of lures of various size, shape, color, movement characteristics in the water, etc., and eliminates the need to own and carry numerous individual static lures. Preferably, a kit also includes a plurality of adhesives, paints, laminates, or other decorative elements of various color, texture, design, etc., for placement on the components, such as the body, the head, and the nose. A cavity 14 defined in the body component 12 allows for placement of accessory elements such as weight, glowing, rattle, or scented elements, etc., as desired.

These and other features are discussed in more detail herein with reference to the figures, in which, FIG. 1 shows an assembled, exemplary lure using a lure system, generally designated as 10, and comprises a body component 12, head component 30, nose component 50, and a connector plug 60 extending between the body component 12 and head component 30.

The body component can be seen in FIGS. 1-2, with exemplary alternative body styles at FIG. 7. The body component 12 defines a cavity 14 therein. The exemplary cavity 14 has a closed end 16, an open end 18, and a cavity wall 20, and extends longitudinally into the body component 12. The cavity can take various shapes, however, in a preferred embodiment the cavity is generally cylindrical for ease of manufacture and assembly with corresponding components. The cavity can be and is preferably water-tight but is not required to be. The cavity is of a size and shape to allow placement of weights, glowing elements, scented objects, noise-makers, or other accessories therein.

Proximate the open end 18 of the cavity 14 is defined a connection device 24 such as tapered or straight threads, interrupted threads, grooves, and friction or interference fit, which cooperates with a corresponding connection device 72 on the connector plug 60. The connection device 24 preferably works in conjunction with a breakaway mechanism, as will be explained. Note also that the connection device 24 is not required to be part of, attached to, or formed from the cavity 14. That is, the connection device can be positioned away from the cavity open end. Preferably the connection device is made of a plastic material, but can alternately be rubber, metal, resin, or a combination of materials.

The body component 12 has a length L, width W, and height H, and can be made to various form, size, shape, and weight. The body can be made to imitate fish species, and can be selected by the sportsman based on type of catch desired, fishing conditions, etc. The body component can be made of various materials. Preferably the body component is made of a plastic material, but can alternately be rubber, metal, resin, or a combination of materials. The body component 12 defines a front surface 26 which preferably abuts a coordinating rear surface 32 of the head component 30 when the lure is assembled.

Extending from the body component 12 are one or more eyes 22 for the attachment of hooks, extension lines with or without other lures, swivels, hooks, and the like. Exemplary eyes 22 are shown attached to the rear and bottom of the body component 12. More or fewer eyes can be used and the placement can vary. Further, the simple U-shaped eyes shown are exemplary only and other forms, such as open or closed screw eyes, hook hangers, and the like, can be used.

Various sizes, shapes, and functions of body component 12 can be employed. FIGS. 1-2 show an exemplary cigar style body. FIGS. 7A-D are elevation views of exemplary body components 12a-d. FIG. 7A is a bait fish style body component, FIG. 7B is a tadpole style body component, FIG. 7C is a humpback style body component, and FIG. 7D is a streamline style body component. The body components are exemplary only and additional style components can be employed. Each body component includes a connection 24a-d for releasable attachment to a cooperating and corresponding connection 68 of the connector plug 60.

As with other components of the assembly, the body components are interchangeable, connectable to connector plugs, and are easily assembled into a lure by hand.

With reference to FIGS. 1 and 3, an exemplary head component is shown. The head component 30 can be made to various form, size, shape, and weight, and, like the body component 12, can be made to imitate fish species or types, and can be selected by the sportsman based on type of catch desired, fishing conditions, etc. The head component can be made of various materials, as with the body.

The head component 30 defines a rear surface 32, preferably planar, which cooperates with corresponding front surface 26 of the body component 12.

The head component 30 preferably defines a nose connector member 36 for cooperation with a corresponding connector member on the nose component 50. The connection can take various form but is preferably easy to assemble by hand. The connection shown is a simple dovetail, friction fit assembly, with a dovetail passage 37 defined on the front end of the head component 30. The particular connection device shown is exemplary and can alternately be tapered or straight threads, interrupted threads, grooves, friction or interference fit, or other various connections known in the art.

Extending from the head component 30 is an eye 38 for the attachment of fishing line and the like. An exemplary eye 38 is shown attached to the upper surface of the head component. More or fewer eyes can be used and the placement can vary. Further, the simple U-shaped eye shown is exemplary and other types of eyes, such as open eyes, closed eyes, screw eyes, embedded eyes, and the like, can be used.

FIG. 10 is a schematic view of an exemplary head component 30 according to an aspect of the invention. In the shown embodiment, secured to the head component 30 is a multi-point eye 39. The multi-point eye 39 allows a line to be attached to the head component 30 at multiple points, namely the individual eyes 39a-c defined by the multi-point eye. The sportsman can select which eye to use based on, for example, the lure angle desired for presentation in the water. Further, the multi-point eye 39 shown is exemplary and other forms, such as open, closed, screw, or embedded eyes, hangers, and the like, can be used. The multi-point eye 39 can be made to various form, size, shape, and weight. The particular individual eye 39a-c to which the fishing line is tied can be selected by the sportsman. The multi-point eye can be made of various materials, as with the body and head components.

The head component 30 includes a connection device 34 for cooperation with a corresponding connection device 64 defined on the connector plug 60. The connection device shown is exemplary and can alternately be tapered or straight threads, interrupted threads, grooves, friction or interference fit, etc., as is known in the art. The connection device 34 preferably works in conjunction with a breakaway mechanism, as explained below.

A preferred connector device 34, as shown, is a quarter-turn, tabbed cavity 42 for cooperation with a corresponding tabbed post 62 on the connector plug 60. Alternate turn ranges may be used. The cavity 42 defines a bore 40 into which a connector plug post fits. Tab cavities 46 are defined and cooperate with corresponding connector plug tabs 64. The tab cavities 46 define shoulders 44 against which the connector plug tabs 64 abut. Additionally, the preferred embodiment includes a resilient member 47, such as an 0-ring or gasket seal, seated in a corresponding recessed seat 48. The resilient member 47 maintains axial pressure on the connector plug 60, when properly connected with head component 30, to increase the seating force of the connector plug tabs 64 against the shoulders 44, thereby preventing accidental disassembly and eliminating any “play” between the assembled components.

As with other components of the assembly, the head components are interchangeable with other heads, connectable to the connector plugs and stowage plugs, and are easily assembled into a lure by hand.

FIG. 4 shows an exemplary connector plug 60. The connector is designed to attach to, and preferably extend into, both the body 12 and head 30 components. Various designs and attachments can be used such as threaded connections, snaps, latches, clips, buckles, friction fits, and the like. The attachment is releasable upon manipulation by the sportsman. In a preferred embodiment, the connector plug 60 is of a breakaway design and is designed to automatically release or disconnect upon application of a pre-selected tension or pulling force.

The connector plug 60 shown is of breakaway design. At one end, a tabbed post 62 connector having two tabs 64 extending radially therefrom, cooperates with the similarly shaped cavity 34 in the head 30. The tabbed post 62 is inserted into the cavity 34 and given a quarter-turn until the tabs 64 are firmly positioned in corresponding tab cavities 46. Alternate turn ranges may be used. The tabs seat against shoulders 44 of the head 30. As explained above, preferably a resilient member 47 acts with axial pressure against the connector plug, thereby more firmly seating the plug tabs 64 against the shoulders 44. The opposite end of the connector plug 60 defines a connection device 68 for cooperation with corresponding connection device 24 defined on the body component 12. The connection device can include threads 72, ridges, grooves, and the like to facilitate a friction fit or other hand-releasable connection. The connector plug 60 preferably has, but does not have to have, a pre-selected tension or pulling force for detachment from the body component 12.

Upon application of a pre-selected tension or pulling force, the preferred connector plug automatically “breaks away” or detaches the head and body components. The connector plug can cause separation of the components by breaking the connector plug, breaking a connection device on the head or body, or, preferably, by disconnecting one end of the plug from the body or head component without causing damage. Where a disconnect design is selected causing damage to a component, it is preferable to limit damage to the body component 12 or the breakaway plug itself, since they are more likely to be lost after the breakaway. Damage to the head component is to be avoided so that the head component remains usable. The breakaway connector plug can be designed to automatically detach from the head 30 or body 12 components.

Breakaway and releasable connections are known in the art and include magnetic attachments, snaps, clips, spin links, pop barrels, tension retainers, and the like. Releasable connectors can be used which are not designed to breakaway during use, however, this is more likely to result in loss of a lure assembly upon a hang-up and/or may cause a line break. The connector plug is easily manually removable, without damage, from the head and body components by the user. In the embodiment shown, the connector plug is simply twisted and pulled out of the head cavity and can be simply removed from the body cavity by the user.

In a preferred embodiment, the connector plug carries a seal 74, such as an O-ring or gasket seal, adjacent the flange 70. This creates a seal between the front surface 26 of the body component 12 and the connector plug. Preferably, this prevents water from penetrating cavity 14 on body component 12, as well as reducing vibration and friction between the connector plug 60 and body component 12 at the abutment of flange 70 and front surface 26. The connector plug is interchangeable with other connector plugs, is easily assembled into a lure by hand, and does not require the use of tools to assemble or disassemble.

The nose component 50 attaches releasably to the head 30 at cooperating connections 52 which corresponds to connection 36 on the head. Various types of connections can be used without departing from the spirit of the invention. Shown is a simple cooperating connection, easily operated by hand, wherein a dovetailed tab 52 slides into a corresponding dovetail passage 37 on the head component 30. The nose component can alternately attach to the head component by locking pin, safety release, tension retainer, clip, or other selectively releasable, hand-operated, connection as is known in the art.

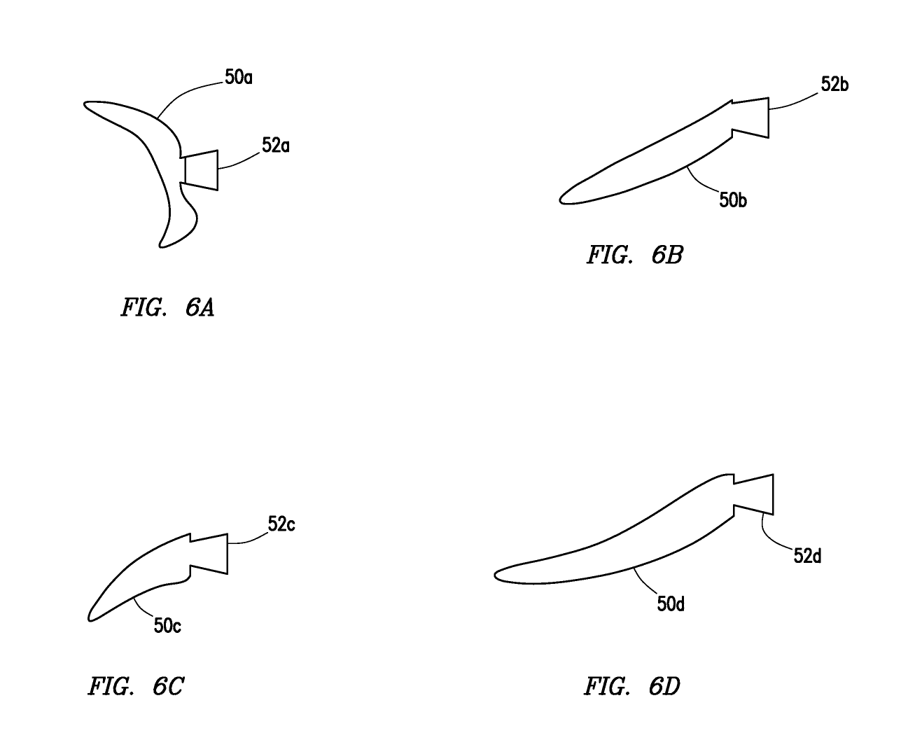

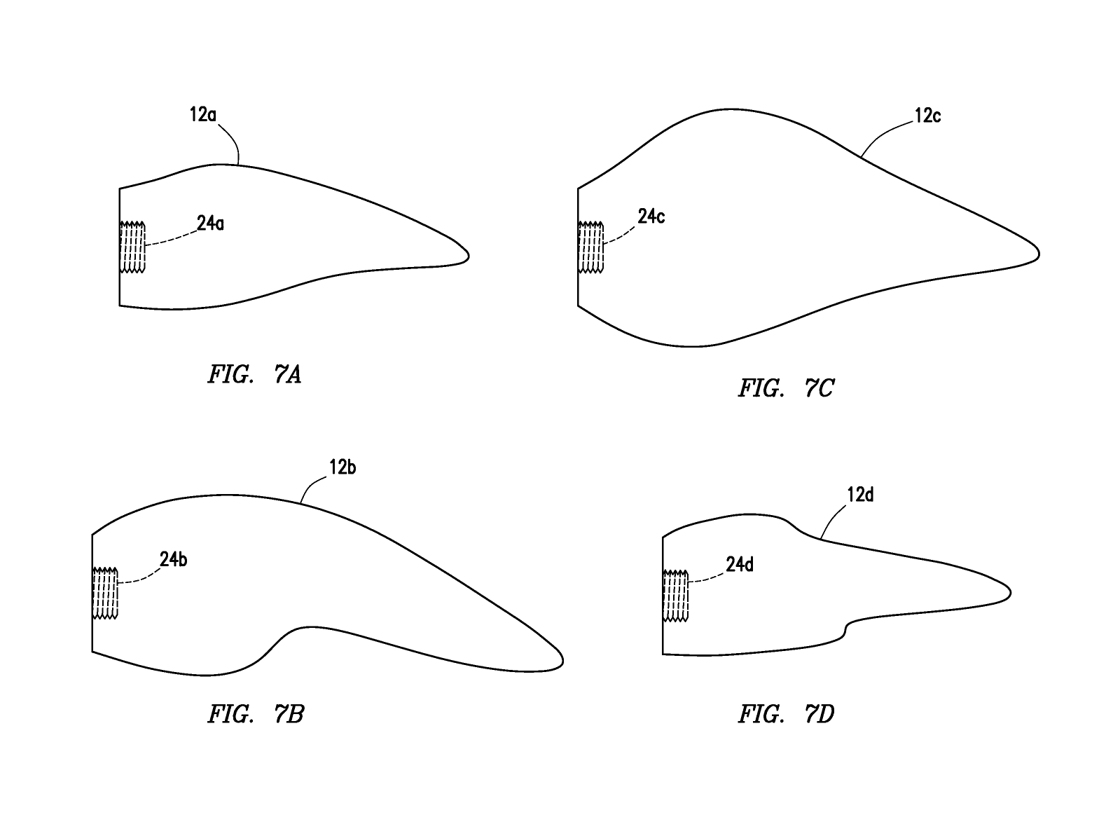

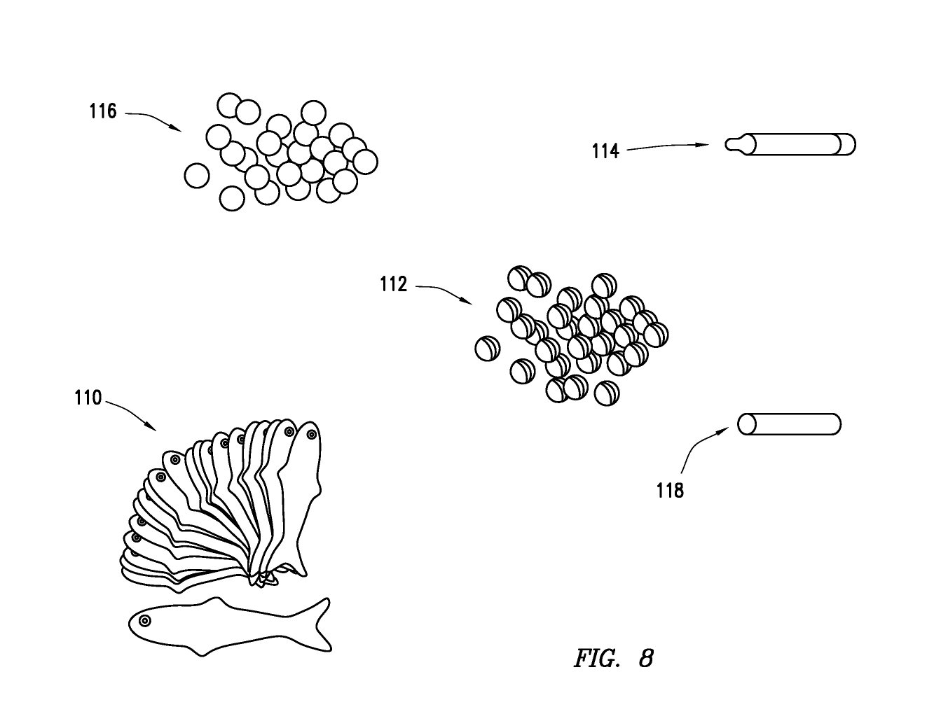

Various sizes, shapes, and functions of nose component 50 can be attached to the head component 30. For example, selected nose components can be propellers, divers, spoons, splash-spoon, lure lips, and the like. FIGS. 6A-D show side elevational views of some exemplary nose components 50a-d. FIG. 6A is a top water splash spoon, FIG. 6B is a medium diver spoon, FIG. 6C is a shallow diver, and FIG. 6D is a deep diver. These nose components are exemplary only and additional nose components can be employed. Each nose component includes a cooperating connection 52a-d for insertion and releasable attachment to corresponding connection 36 of the head 30. The nose components can be made to various form, size, shape, and weight, and can be selectable by the user. As with the other components of the lure assembly, the nose components can be made of various materials, are interchangeable, and easily assembled by hand.

FIG. 5 shows an exemplary stowage plug 90 which is connectable to the head component 30 of the lure in a manner similar to that of the connector plug 60. The stowage plug 90 is used to replace the connector plug 60 for ease of stowing and storage of the lure components without requiring untying the head and nose from the line. The plug 90 has a manually releasable connector device 92, shown as a post 96 with radially extending tabs 94 which cooperates with the cavity 34, bore 40, and tab cavities 46 defined in the head 30. Note that any hooks attached to the body component 12 are removed from the lure assembly upon removal of the body component 12 from the assembly. The body component and hooks can be stored in a tackle box. Inserting the stowage plug in the head component then allows for safe connection of the head component 30, tied to the free end of the line, to the rod without risk of injury from the hooks during stowage and transport. The stowage plug is interchangeable with connector plugs and other stowage plugs and is easily assembled into a lure by hand.

The opposite end of the stowage plug 90 provides a connection device 98 allowing ease of connection of the head component 12 at the free end of the line to the rod. Shown is a preferred connection device 98 having one or more holes or passageways 102 defined therein for use in attaching the connection device 98 to the rod or any part thereof. The connection device 98 can vary in shape, size, and type, allows connection to objects such as a fishing rod, key chain, etc., and can be secured to such items by various means, such as a rubber ring, hook and loop connector, snaps, or other fasteners as are known in the art.

FIG. 8 is a schematic of exemplary accessories for use in embodiments according to the invention. Adhesives 110, paints, laminates, static stickers, tension stickers, or other decorative, design, style, texture, or scented elements can be applied to the modular lure assembly or parts thereof. The adhesives 110 can have selected color, design, texture, sheen, and scent, and can be designed to mimic selected species if desired. The adhesives can be permanent or detachable from the lure after initial placement. Further, the adhesives can alternately be attachable to the lure parts by other means, such as glue, cooperating connectors, fasteners, etc. Other accessories for use with the fishing lure include items insertable into the cavity 14 of the body component 12. For example, weight elements 112, glowing elements 114, rattle elements 116, scented elements 118, etc.

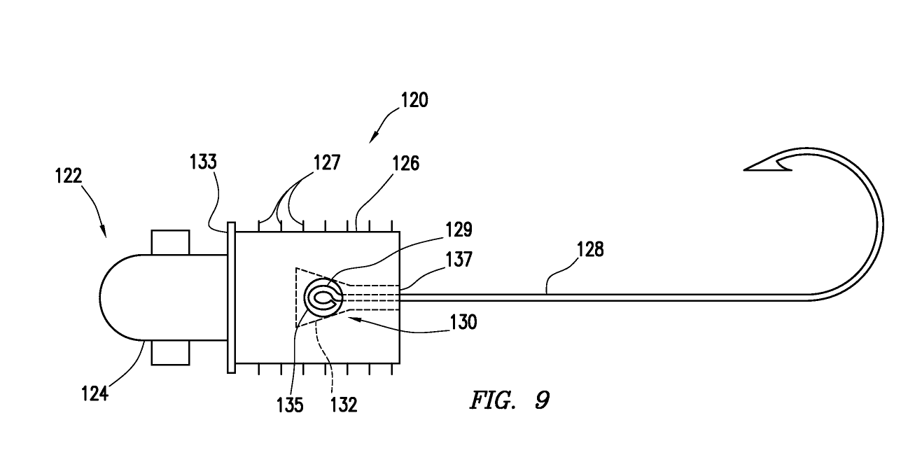

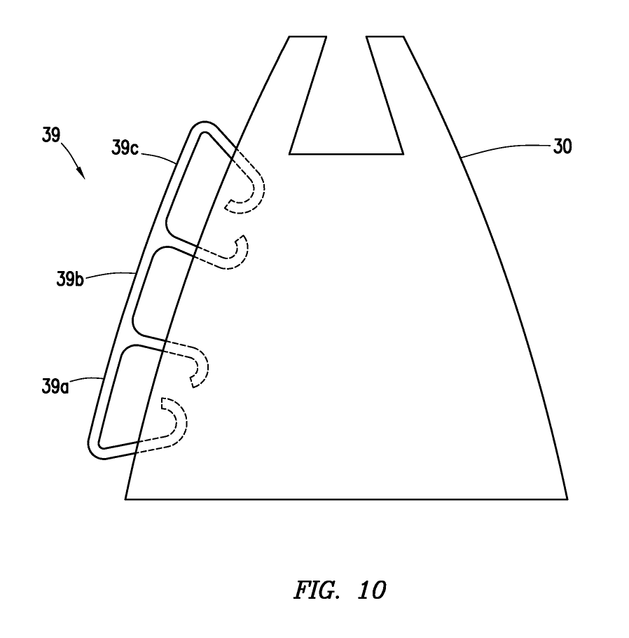

FIG. 9 is an elevational view of an exemplary soft or live bait component for use in accordance with the invention. The soft or live bait component 120 has a connection device 122 defined at one end for connecting the soft or live bait component to a head component 30. Shown is a connection device similar to those described herein with respect to the connector plug, although other connection devices can be employed. The shape and operation of the tabbed post 124 connector will not be described again in detail. The tabs and post fit into corresponding cavities in the head component 30 and the flange 133 abuts the rear surface 32 of the head component 30. The soft or live bait component 120 has a main body 126 which can be provided with decorative accessories, as desired. A hook 128 is secured at connection 130, preferably removably, to or within the material comprising the main body 126. As seen in FIG. 9, a hook 128 having an eye 129 is inserted into the connection 130. The exemplary connection 130 is a universal receiving slot or keyhole. The hook is inserted into the universal slot or keyhole via a side port 135 and pulled through longitudinal port 137 until the hook eye 129 seats against the tapered cavity 132 defined in the body 126. The tapered cavity allows for insertion and holding of hooks with various sized eyes. The connection 130 can alternately be used to attach other items, such as, for example, a swivel or snap-swivel. Additionally, the soft or live bait component can have a plurality of barbs 127 for attaching live or soft bait to the component.

The soft or live bait component 120 with connection device 122 can have the features and functions described regarding connector plug 60 above, including breakaway functionality. The soft or live bait component can be made to various form, size, shape, and weight, and can be selectable by the user. As with the other components of the lure assembly, the soft or live bait component can be made of various materials, are interchangeable, and easily assembled by hand.

The modular fishing lure assembly is presented and used as a kit of separate but cooperative parts of a size and shape to fit conformingly to other kit parts. An exemplary kit includes the following assembly parts: one or more body components, head components, and nose components, one or more breakaway and/or manually releasable connector plugs, one or more manually releasable stowage plugs, and a plurality of accessories (such as adhesive, rattle, weight, or scented elements). Multiple shapes, sizes, and functions of body, head, and nose components can be included in a kit. For example, a kit can include a head component, a cigar style body component, a bait fish body component, a medium diver nose component, a shallow diver nose component, multiple connector plugs, preferably of breakaway design and each having a different pre-selected disconnect force, a stowage plug, a fastener for attaching the stowage plug to, for example, a rod, a plurality of adhesives (or pairs of adhesives) for the opposite sides of a body, head, and/or nose component, such as three sets of adhesives of various color and/or patterns for the body component styles, nose component styles, and head components in the kit. Kits can comprise some or all of the listed assembly parts, in various numbers, as well as additional parts such as, but not limited to, soft or live bait components, swivels, and fishing hooks. The kit provides an assembly system for creating a plurality of fishing lure combinations at the selection of the user. The kit can also include soft body components for use with soft or live bait components.

In another exemplary kit, the following components are supplied for assembly and disassembly by hand in the field by the sportsman. The cooperating components are or include: at least one head component, at least two nose components, at least two soft or live bait components, a plurality of hooks, a plurality of soft or live bait bodies of various form, size, shape, weight, color, texture, etc., and at least one stowage plug. As with the other components of the lure assembly, the soft or live bait bodies can be made of various materials, are interchangeable, and easily assembled by hand.

The following disclosure is provided in support of the methods claimed or which may be later claimed. Specifically, this support is provided to meet the technical, procedural, and substantive requirements of certain examining offices. It is expressly understood that the portions or actions of the methods can be performed in any order, unless specified or otherwise necessary, that each portion of the method can be repeated, performed in orders other than those presented, that additional actions can be performed between the enumerated actions, and that, unless stated otherwise, actions can be omitted or moved. Those of skill in the art will recognize the various possible combinations and permutations of actions performable in the methods disclosed herein without an explicit listing of every possible such combination or permutation. It is explicitly disclosed and understood that the actions disclosed, both herein below and throughout, can be performed in any order (xyz, xzy, yxz, yzx, etc.).

In use, the fishing lure assembly is taken into the field, such as at a dock or on a boat. One of a plurality of body components, head components, and connector plugs are selected for assembly, and optionally a nose component. The body component is attached, releasably and by hand, to one end of the connector plug such as by friction fit, interference fit, threaded connection, etc. Similarly, the head component is attached, releasably and by hand, to the other end of the connector plug, such as by friction fit, interference fit, threaded connection, etc. The head is tied to the fishing line at a fishing lure eye on the head. The body component is attached to one or more hooks via one or more fish hook eyes on the body component. If desired, a nose component is releasably and by hand attached to the head component. If desired, one or more decorative adhesives and/or accessory elements are attached to the head component or body component. The assembled fishing lure is used for fishing. In a preferred embodiment, the connector plug, after being caught on an obstruction in or near the water, breaks away and at least the head component is retrieved. Additionally, the connector plug may be retrieved attached to the head component. In one embodiment, the connector plug breaks away resulting in permanent damage to one or more of the plug, head component, and body component. In another embodiment, the plug breaks away without damaging at least one of the head component, plug, and body component. After fishing, any of the head component, body component, connector plug, or nose components are interchanged with additional such components. The body components and nose components are interchanged with other such components without removing the head component from the fishing line. Upon completion of fishing, the connector plug is replaced with an interchangeable stowage plug, which is releasably, by hand, connected to the head component without removing the head component from the fishing line. The stowed assembly has a head component, without hooks, tied to the line and releasably, by hand, connected to the rod or a part thereof, and a body component, with or without hooks still attached, stowed safely, such as in a tackle box. Further methods include placing and replacing adhesives or other decorations on one or more head, body or nose components; placing and replacing accessory elements in a cavity defined in the body component; replacing a lost connector plug and/or body component with additional such components; and disassembly, by hand, of two or more of the head, body, and nose components.

While this disclosure has been described with reference to illustrative embodiments, this description is not intended to be construed in a limiting sense. Various modifications and combinations of the illustrative embodiments as well as other embodiments of the disclosure will be apparent to persons skilled in the art upon reference to the description. It is, therefore, intended that the appended claims encompass any such modifications or embodiments.

1. A modular fishing lure assembly capable of being hand-assembled in the field comprising:
a plurality of interchangeable body components, each body component having at least one eye for attaching at least one hook to the body component;
at least one head component having an eye for connecting to a fishing line;
a plurality of interchangeable connector plugs, the opposing ends of each connector plug having repeatedly releasable, hand-operated connectors for easily and quickly connecting and disconnecting the connector plug to the head component or body components without damaging the connector plug, head component, or body components;
a plurality of interchangeable nose components for controlling the action of the lure in the water and adapted for releasable connection by hand to the head component; and
wherein a plurality of fishing lures of varying appearance are able to be easily and quickly assembled and disassembled by in the field.

2. The modular fishing lure assembly of claim 1, wherein each body component comprises a body cavity sized to accommodate at least one accessory element, the accessory element selected from the group consisting of: weights, rattles, scented elements, glowing elements, and combinations thereof.

3. The modular fishing lure assembly of claim 1, further comprising at least one soft bait connector plug for connecting soft or live bait to a head component.

4. (canceled)

5. The modular fishing lure assembly of claim 1, wherein at least one of the connector plugs comprises a breakaway plug to disconnect from at least one of an attached head or body component upon application of a selected force.

6. The modular fishing lure assembly of claim 5, wherein the breakaway plug disconnects without damaging head or body components.

7. The modular fishing lure assembly of claim 5, wherein the breakaway plug disconnects without damaging the breakaway plug.

8. The modular fishing lure assembly of claim 5, wherein the breakaway plug disconnects upon application of a force selected according to the rating of a fishing line.

9. The modular fishing lure assembly of claim 1, wherein at least one connector of the connector plugs is selected from the group of connector types consisting of: friction-fit, quarter-turn, easily threaded tapered, interrupted, or straight thread fasteners snap-in, and interference fit.

10. The modular fishing lure assembly of claim 9, wherein at least one opposing end of each connector plug is releasably connected by hand-operation to a head or body component by a tabbed post cooperating with a corresponding cavity defined in the head or body component.

11. The modular fishing lure assembly of claim 1, further comprising at least one stowage connector plug having an end releasably connected to the head component.

12. The modular fishing lure assembly of claim 11, wherein the stowage connector plugs and connector plugs are interchangeably attachable to the head component.

13. The modular fishing lure assembly of claim 11, wherein at least one end of the stowage connector plug is releasably connected by hand-operation to a fishing rod.

14. The modular fishing lure assembly of claim 1, wherein the nose components are selected from a group consisting of: deep divers, shallow divers, spoons, and splash-spoons.

15. The modular fishing lure assembly of claim 1, wherein the nose components are adapted to be releasably attached to the head components by friction fit.

16. The modular fishing lure assembly of claim 1, further comprising a multi-point eye attached to the head component, the multi-point eye defining multiple eyes in a single, fixed element for attachment to a line for selecting a desired lure angle for presentation in the water.

17. The modular fishing lure assembly of claim 1, further comprising at least one decorative element for attachment to at least one of a body, head, or nose component, the decorative element selected from the group consisting of: adhesives, paints, or laminates.

18. A fishing lure assembly kit to form selectively changeable fishing lures, the kit comprising:
multiple body components each having a releasable connection and at least one fishing hook eye;
at least one head component having a releasable connection and a fishing line eye;
multiple connector plugs each having a first end defining a releasable connection cooperable with the releasable connection of the at least one body, and a second end defining a releasable connection cooperable with the releasable connection of the at least one head component, the releasable connections hand-operable in the field for allowing easy and quick disconnection of the head component from a body component having a hooked fish for safer retrieval of the fish;
at least one nose component to control the action of the lure, the nose component defining a hand-operable releasable connection cooperable with a corresponding connection defined on the at least one head component.

19. The fishing lure assembly kit of claim 18, further comprising a plurality of accessory elements adapted for insertion into a cavity defined in the at least one body, the accessory elements selected from the group consisting of: weights, rattles, glowing elements, and scented elements.

20. The fishing lure assembly kit of claim 18, wherein at least one connector plug is a breakaway plug.

21. The fishing lure assembly kit of claim 18, wherein at least one connector plug is a stowage plug.

22. The fishing lure assembly kit of claim 18, further comprising at least one soft or live bait component.
